(19) United States
(12) Patent Application Publication
(10) Pub. No.: US 2009/0022436 A1
(43) Pub. Date: Jan. 22, 2009

(54) BEARING UNIT, MOTOR AND DISK DRIVE APPARATUS WITH THE BEARING UNIT

(75) Inventor: Sakurada Kunio, Kyoto (JP)

Correspondence Address: VOLENTINE & WHITT PLLC, ONE FREEDOM SQUARE, 11951 FREEDOM DRIVE SUITE 1260, RESTON, VA, 20190, US

(73) Assignee: NIDEC CORPORATION, Kyoto (JP)

(21) Appl. No.: 12/173,082

(22) Filed: Jul. 15, 2008

(30) Foreign Application Priority Data
Jul. 19, 2007 (JP) 2007-188264

(51) Int. Cl. F16C 32/06; H02K 21/12; G11B 5/82

(52) U.S. Cl. 384/12; 310/156.01; 360/135

(57) ABSTRACT

A bearing unit includes a shaft, a tubular bearing member, a planar plate fixed to a lower side of the bearing member and a lubricant filled between the shaft and an inner circumferential surface of the bearing member. In the bearing member, an inner circumferential wall portion is axially downwardly protruding from a lower surface of the bearing member and has a first surface contacting with and extending in a parallel with an upper surface of the plate and a second surface axially spaced apart from the upper surface of the plate. An outer circumferential wall portion is positioned radially outwardly of the second surface. The plate is fixed to the outer circumferential wall portion of the bearing member, and a radial inner side of the inner circumferential wall portion communicates with the outer circumferential wall portion through a gap formed between the second surface and the slate.

### FIELD OF THE INVENTION

The present invention relates to a bearing unit and, more particularly, a technique of expelling the air present within a bearing unit to the outside of the bearing unit. The present invention is also directed to a motor and a disk drive apparatus with the bearing unit.

### BACKGROUND OF THE INVENTION

In a motor for rotating a magnetic disk such as a hard disk or the like, a highly accurate deflection of rotational vibration is required in order to prevent the magnetic disk from making contact with a magnetic head. Typically, a sliding bearing such as a dynamic pressure fluid bearing or the like is used in this kind of motor. Unlike an optical disk including a CD and a DVD, a hard disk drive apparatus requires a high degree of reliability because the apparatus itself serves as one element of a storage medium. Accordingly, a high degree of reliability is also required in the motor, one of constituent parts of the hard disk drive apparatus.

A motor structure that employs a conventional sliding bearing will be described with reference to FIG. 12 which is an axially-cut schematic section view of a motor having a conventional sliding bearing.

Referring to FIG. 12, a motor 1 includes: a rotating part 2 having a shaft 2a rotating about a specified center axis J1, a rotor hub 2b fixed to an upper portion of the shaft 2a for sustaining a magnetic disk (not shown) and a rotor magnet 2c fixed to the rotor hub 2b; a fixed part 3 having a sleeve 3a with an axially bored inner circumferential surface for rotatably supporting the shaft 2a, a plate 3b fixed to a lower surface of the sleeve 3a to cover the inner circumferential surface of the sleeve 3a from below and a stator 3c fixed to the sleeve 3a opposite to the rotor magnet 2c; and a lubricant 4 filled between the outer circumferential surface of the shaft 2a and the inner circumferential surface of the sleeve 3a.

A circumferential wall 3a1 radially confronting the outer circumferential surface of the plate 3b is formed in the sleeve 3a. The upper surface and the outer circumferential surface of the plate 3b make contact with the lower surface of the sleeve 3a and the inner circumferential surface of the circumferential wall 3a1, respectively (see Japanese Patent Laid-open Publication No. 2006-136180 for an example of the conventional motor structure).

In this regard, the outer circumferential edge of the upper surface of the plate 3b is chamfered circumferentially in order to prevent a crack of the plate 3b. Therefore, a circumferential gap 5 is formed between the upper surface of the plate 3b, the lower surface of the sleeve 3a and the U5 circumferential wall 3a1 of the sleeve 3a. Air exists in the gap 5. Thus, there is a possibility that the air existing in the gap 5 may enter between the inner circumferential surface of the sleeve 3a and the outer circumferential surface of the shaft 2a through a narrow gap between the upper surface of the plate 3b and the lower surface of the sleeve 3a.

Furthermore, there is a possibility that a plurality of air bubbles may be combined together and big air bubbles may exist between the inner circumferential surface of the sleeve 3a and the outer circumferential surface of the shaft 2a. Consequently, the lubricant 4 does not exist in certain portions between the inner circumferential surface of the sleeve 3a and the outer circumferential surface of the shaft 2a. As a result, the inner circumferential surface of the sleeve 3a and the outer circumferential surface of the shaft 2a may possibly come into direct contact with each other and may be stuck together.

### SUMMARY OF THE INVENTION

The present invention provides a highly reliable bearing unit capable of reducing the generation of air bubbles in between a shaft and a sleeve and eventually preventing the shaft and the sleeve from sticking together, and a motor and a disk drive apparatus provided with the bearing unit.

In accordance with a first aspect of the present invention, there is provided a bearing unit including: a shaft coaxially arranged with a specified center axis; a generally tubular bearing member having an axially extending through-hole into which the shaft is inserted; a generally planar plate fixed to an axial lower side of the bearing member for covering an axial lower side of the through-hole; and a lubricant filled between the shaft and an inner circumferential surface of the bearing member, wherein the bearing member includes: a generally annular or generally arc-shaped inner circumferential wall portion axially downwardly protruding from a lower surface of the bearing member, the inner circumferential wall portion having a first surface contacting with an upper surface of the plate and extending in a parallel relationship with the upper surface of the plate and a second surface axially spaced apart from the upper surface of the plate so that an axial gap is left between the second surface and the upper surface of the plate, the second surface being located generally radially identical with the first surface; and an outer circumferential wall portion positioned radially outwardly of the second surface, the outer circumferential wall portion having a circumferential surface downwardly extending relative to the second surface along a generally axial direction, wherein the plate is fixed to the outer circumferential wall portion of the bearing member, wherein a radial inner side of the inner circumferential wall portion communicates with the outer circumferential wall portion through the axial gap formed between the second surface and the plate.

In accordance with a second aspect of the present invention, there is provided a bearing unit including: a shaft coaxially arranged with a specified center axis; a generally cylindrical bearing member having an axially extending through-hole into which the shaft is inserted and a communication hole arranged radially outwardly of the through-hole, the communication hole extending from an upper surface to a lower surface of the bearing member; a generally planar plate fixed to an axial lower side of the bearing member for covering an axial lower side of the through-hole; and a lubricant filled between the shaft and an inner circumferential surface of the bearing member, wherein the bearing member includes: a generally arc-shaped inner circumferential wall portion formed in a radially identical position with the communication hole, the inner circumferential wall portion protruding axially downwardly from the lower surface of the bearing member over a circumferentially different position than the communication hole to make contact with an upper surface of the plate; and a generally annular outer circumferential wall portion positioned radially outwardly of the inner circumferential wall portion, the outer circumferential wall portion having a circumferential surface extending in a generally axial direction.

In accordance with a third aspect of the present invention, there is provided a bearing unit including: a shaft coaxially arranged with a specified center axis; a generally tubular bearing member having an axially extending through-hole into which the shaft is inserted; a generally planar plate fixed to an axial lower side of the bearing member for covering an axial lower side of the through-hole; and a lubricant filled between the shaft and an inner circumferential surface of the bearing member, wherein the bearing member includes: an inner circumferential wall portion axially downwardly, protruding from a lower surface of the bearing member to make contact with an upper surface of the plate; an outer circumferential wall portion having a circumferential surface extending in a generally axial direction; and an annular upper recess portion radially formed between the inner circumferential wall portion and the outer circumferential wall portion and axially upwardly recessed from a lower end of the inner circumferential wall portion, wherein the plate is fixed to the outer circumferential wall portion of the bearing member, wherein a recess portion which is extending radially and recessed downwardly is formed in a circumferentially partial region of the upper surface of the plate, wherein a radial inner side of the inner circumferential wall portion communicates with the outer circumferential wall portion through the recess portion of the plate.

With such configurations, the space formed between the inner circumferential wall portion and the outer circumferential wall portion is allowed to communicate with the space formed inside the bearing member so that the air present in the space formed between the inner circumferential wall portion and the outer circumferential wall portion can be expelled to the outside. This makes it possible to prevent the shaft and the bearing member from sticking together, which would otherwise be caused by the air bubbles present inside the bearing member. As a result, it is possible to provide a highly reliable bearing unit.

It is preferable that the communication hole is joined to the upper surface of the bearing member by means of a slanting surface whose diameter is increased upwardly.

In this configuration, by forming the slanting surface between the communication hole and the upper surface, it is possible to remove burrs that would be occur at the upper surface when the communication hole is formed.

It is preferable that the inner circumferential wall portion has an outer slanting surface extending downwardly and radially inwardly.

In this configuration, by forming the slanting surface on the outer surface of the inner circumferential wall portion, it is possible to reduce the radial area of the inner circumferential wall portion that makes contact with the plate while increasing the strength of the inner circumferential wall portion. Further, it is possible to reduce the tilt of the plate which would be caused depending on the degree of planarity of the inner circumferential wall portion so that the plate is mounted to the bearing unit with increased accuracy.

The shaft may include an increased diameter portion having an upper surface axially confronting the lower surface of the bearing member, the increased diameter portion having an outer edge located radially inwardly of the inner circumferential wall portion.

In accordance with a fourth aspect of the present invention, there is provided a bearing unit including: a shaft coaxially arranged with a specified center axis; a generally tubular bearing member having an axially extending through-hole into which the shaft is inserted; a generally planar plate fixed to an axial lower side of the bearing member for covering an axial lower side of the through-hole; and a lubricant filled between the shaft and an inner circumferential surface of the bearing member, wherein the bearing member includes: an inner circumferential wall portion axially downwardly protruding from a lower surface of the bearing member to make contact with an upper surface of the plate; and an outer circumferential wall portion having a generally axially extending circumferential surface formed radially outwardly of the inner circumferential wall portion, wherein the plate is fixed to the outer circumferential wall portion of the bearing member, wherein a gap is formed between the inner circumferential wall portion and the plate so that a space formed radially inwardly of the inner circumferential wall portion communicates in a radial direction with a space formed radially outwardly of the inner circumferential wall portion through the gap.

With such configuration, the space formed between the inner circumferential wall portion and the outer circumferential wall portion is allowed to communicate with the space formed inside the bearing member so that the air present in the space formed between the inner circumferential wall portion and the outer circumferential wall portion can be expelled to the outside. This makes it possible to prevent the shaft and the bearing member from sticking together, which would otherwise be caused by the air bubbles present inside the bearing member. As a result, it is possible to provide a highly reliable bearing unit.

In accordance with a fifth aspect of the present invention, there is provided a motor provided with the bearing unit described above including: a rotating part, rotatable together with the shaft, having a rotor magnet; and a fixed part including a housing having an inner circumferential surface for holding an outer circumferential surface of the bearing member and a stator fixed to the housing in a confronting relationship with the rotor magnet for generating magnetic fields.

With such configuration, it is possible to provide a highly reliable motor, which prevents the shaft and the bearing member from sticking together.

The bearing member and the housing may be fixed to each other by an adhesive agent. Further, the outer circumferential wall portion has an outer circumferential surface formed radially inwardly of the outer circumferential surface of the bearing member in such a manner as to confront the inner circumferential surface of the housing with a radial gap left between the outer circumferential surface of the outer circumferential wall portion and the inner circumferential surface of the housing, and the adhesive agent is collected between the outer circumferential surface of the outer circumferential wall portion and the inner circumferential surface of the housing.

With such configuration, it is possible to provide a motor, which improves a fixation strength of the bearing member and the housing. Particularly, the fixation strength is obtained by arranging the communication hole in the bearing member. In this case, air present in the space formed between the inner circumferential wall portion and the outer circumferential wall portion can be expelled to the outside of the bearing through the communication hole extending through the inner circumferential wall portion. Accordingly, it is possible to provide a highly reliable motor.

In accordance with a sixth aspect of the present invention, there is provided a disk drive apparatus equipped with the motor described above including: a disk mounted to the rotating part; an access mechanism performing at least one of recording information on and reproducing from the disk; and an actuator for moving the access mechanism.

With such configuration, it is possible to provide a highly reliable disk drive apparatus equipped with the highly reliable motor capable of preventing the shaft and the bearing member from sticking together.

In accordance with the present invention, it is possible to provide a highly reliable bearing unit capable of reducing the generation of air bubbles in between a shaft and a sleeve and eventually preventing the shaft and the sleeve from sticking together, and a motor and a disk drive apparatus provided with the bearing unit.

### BRIEF DESCRIPTION OF THE DRAWINGS

The object and features of the present invention will become apparent from the following description of embodiments given in conjunction with the accompanying drawings, in which:

FIG. 1 is an axially-cut schematic section view showing a motor in accordance with a first embodiment of the present invention;

FIG. 2 is an axially-cut schematic section view showing a bearing unit in accordance with the present invention;

FIG. 3 is an enlarged view of the portion indicated by a dot line circle in FIG. 2;

FIG. 4 is a schematic bottom view of a sleeve employed in the motor shown in FIG. 1;

FIG. 5 is an axially-cut schematic section view showing a motor in accordance with a second embodiment of the present invention;

FIG. 6 is an axially-cut schematic section view showing a bearing unit in accordance with the present invention;

FIG. 7 is an enlarged view of the portion indicated by a dot line circle in FIG. 6;

FIG. 8 is a schematic bottom view of a sleeve employed in the motor shown in FIG. 5;

FIG. 9 is an axially-cut schematic section view showing a modification type of bearing unit in accordance with the first embodiment of present invention;

FIG. 10 is a bottom view of a plate employed in the bearing unit shown in FIG. 9;

FIG. 11 is an axially-cut schematic section view showing a disk drive apparatus in accordance with the present invention; and

FIG. 12 is an axially-cut schematic section view illustrating a conventional motor.

### DETAILED DESCRIPTION OF THE EMBODIMENTS

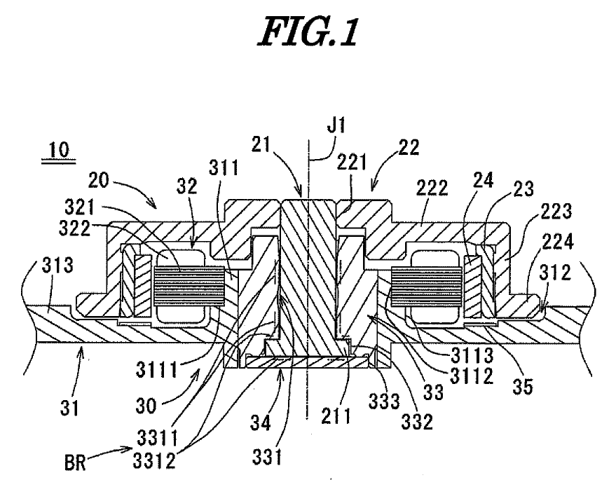

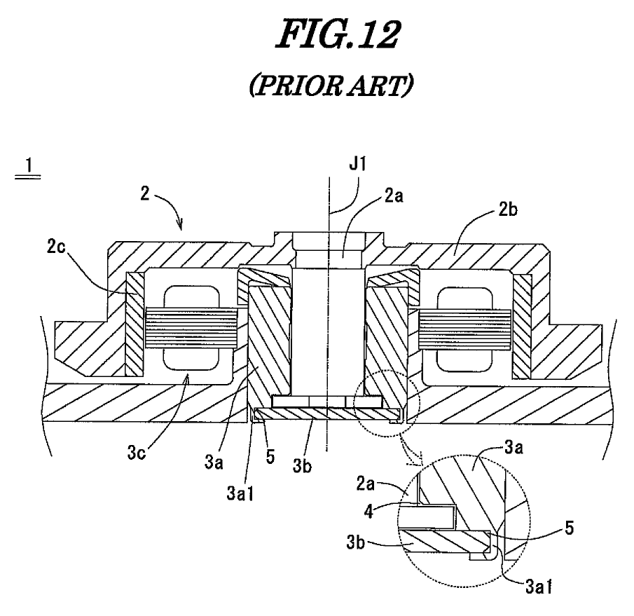

Referring to FIGS. 1 through 12, preferred embodiments of the present invention will be described in detail. It should be noted that in the explanation of the present invention, when positional relationships among and orientations of the different components are described as being up/down or left/right, ultimately positional relationships and orientations that are in the drawings are indicated; positional relationships among and orientations of the components once having been assembled into an actual device are not indicated. Meanwhile, in the following description, an axial direction indicates a direction parallel to a rotation axis, and a radial direction indicates a direction perpendicular to the rotation axis.

### Motor Structure of First Embodiment

A structure of a motor in accordance with a first embodiment of the present invention will now be described with reference to FIG. 1. FIG. 1 is an axially-cut schematic section view showing a motor in accordance with the first embodiment of the present invention.

Referring to FIG. 1, a motor 10 includes: a rotating part 20 having a rotor magnet 24 rotatable about a specified center axis J1; a fixed part 30 having a stator 32 arranged in a radially confronting relationship with the rotor magnet 24 for generating magnetic fields and a base 31 for holding the stator 32 in place; and a bearing mechanism BR provided between the rotating part 20 and the fixed part 30.

The rotating part 20 includes a shaft 21 coaxially arranged with the center axis J1 for rotating about the center axis J1, a rotor hub 22 fixed to an upper portion of the shaft 21 and provided with a disk support portion 224 for sustaining a rotated member (a disk-shaped storage medium (hereinafter, simply referred to as a “disk”) in the present embodiment), a rotor yoke 23 fixed to the rotor hub 22 and a rotor magnet 24 fixed to the rotor yoke 23.

The shaft 21 has a generally columnar shape. Furthermore, the shaft 21 is provided at its lower end with an increased diameter portion 211 whose diameter is greater than that of the remaining portion of the shaft 21.

The rotor hub 22 includes a shaft-fixed portion 221 fixed to the shaft 21, a cover portion 222 formed axially below the shaft-fixed portion 221 to cover an upper portion of the stator 32, a cylindrical portion 223 extending axially downwardly from an outer circumferential edge of the cover portion 222, and the disk support portion 224 extending radially outwardly from the cylindrical portion 223 for sustaining a disk. The rotor yoke 23, which is produced by forming a magnetic steel plate into a generally cylindrical shape, is fixed to an inner circumferential surface of the cylindrical portion 223 of the rotor hub 22. The rotor magnet 24 of a cylindrical shape is fixed to an inner circumferential surface of the rotor yoke 23.

The fixed part 30 includes a generally cylindrical sleeve 33 having an inner circumferential surface axially extending in a confronting relationship with the outer circumferential surface of the shaft 21, a disk-like plate 34 for covering the lower side of the inner circumferential surface of the sleeve 33, a base 31 having an axially bored cylindrical holding portion 311 with an inner circumferential surface to which the outer circumferential surface of the sleeve 33 is fixed, and a stator 32 having an inner circumferential surface fixed to the outer circumferential surface of the cylindrical holding portion 311 of the base 31. In this regard, the sleeve 33 serves as a bearing member.

The base 31 includes, the cylindrical holding portion 311, a circular recess portion 312 radially outwardly extending from the cylindrical holding portion 311, and a flat portion 313 radially outwardly extending from the circular recess portion 312. The circular recess portion 312 has an inner circumferential surface radially opposite to the outer circumferential surface of the disk support portion 224. A yoke 35 formed of an annular magnetic body is fixed at a radial position on the circular recess portion 312 axially opposite to the lower surface of the rotor magnet 24.

The cylindrical holding portion 311 has at the outer circumferential portion thereof, a stator supporting surface 3111 for sustaining the stator 32 which is a radially annually extending flat surface, a first outer circumferential surface 3112 axially upwardly extending from the stator supporting surface 3111 and radially confronting the inner circumferential surface of the stator 32, and a second outer circumferential surface 3113 axially downwardly extending from the stator supporting surface 3111 and joining to the circular recess portion 312. The first outer circumferential surface 3112 has a diameter smaller than that of the second outer circumferential surface 3113.

The stator 32 includes a stator core 321 formed of a plurality of axially laminated thin magnetic steel plates, the stator core 321 having a through-hole that forms an inner circumferential surface of the stator 32, and coils 322 formed of a conductive wire wound around the stator core 321 in plural layers. The stator core 321 has an outer circumferential surface radially confronting the inner circumferential surface of the rotor magnet 24.

Magnetic fields are generated around the stator 32 by causing an electric current to flow through the coils 322 of the stator 32. Rotating magnetic fields are formed by the magnetic fields and the rotor magnet 24, thereby producing a rotational driving force about the center axis J1 to rotate the rotating unit 20.

<Structure of Bearing Unit>

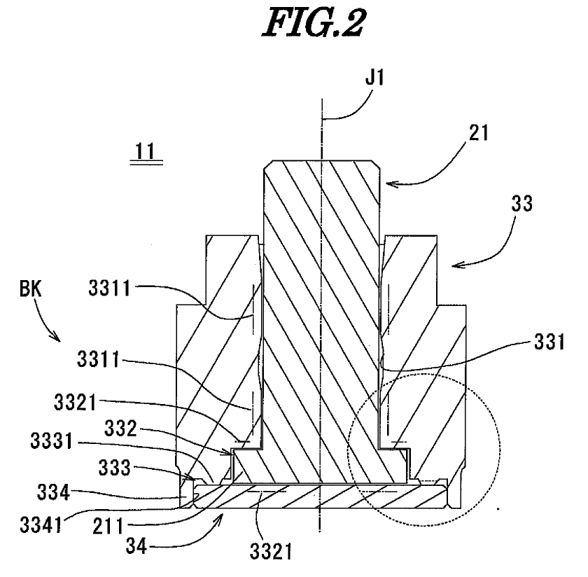

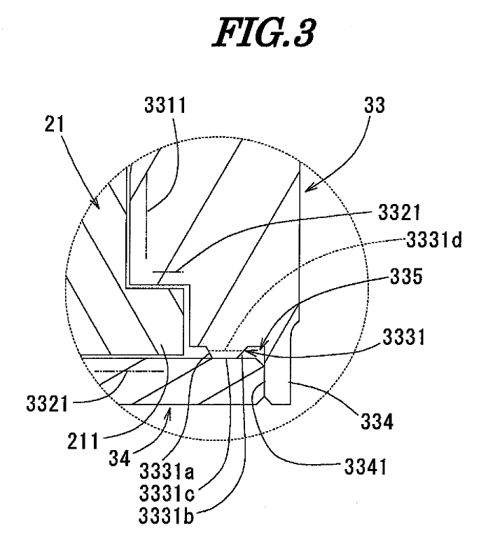

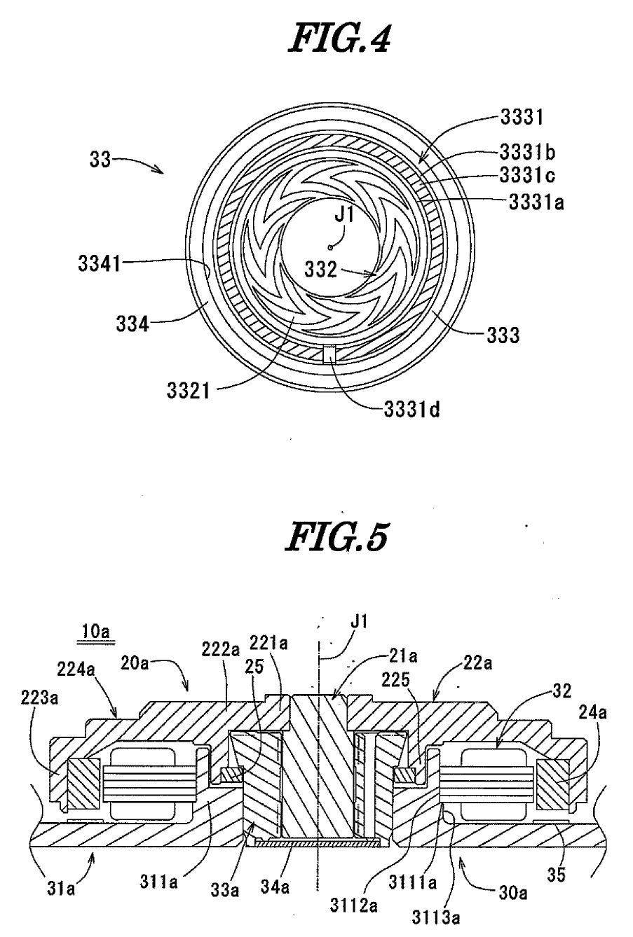

Next, a structure of a bearing unit 11 employed in the motor 10 in accordance with the first embodiment of the present invention will be described with reference to FIGS. 2 to 4. FIG. 2 is an axially-cut schematic section view showing the bearing unit 11 employed in the motor 10 shown in FIG. 1. FIG. 3 is an enlarged view of the portion indicated by a dotted line circle in FIG. 2. FIG. 4 is a schematic bottom view of the sleeve 33.

Referring to FIG. 2, the bearing unit 11 of the motor 10 includes the shaft 21, the sleeve 33 and the plate 34.

The sleeve 33 includes an inner circumferential surface 331 confronting the outer circumferential surface of the shaft 21, a first recessed portion 332 for receiving the increased diameter portion 211 of the shaft 21 the first recessed portion 332 having an inner circumferential surface whose diameter is greater than that of the inner circumferential surface 331 and a second recessed portion 333 formed axially below the first recessed portion 332 for receiving the plate 34, the second recessed portion 333 having an inner circumferential surface whose diameter is greater than that of the inner circumferential surface of the first recessed portion 332. Therefore, the increased diameter portion 211 of the shaft 21 remains in an axially confronting relationship with the bottom surface of the first recessed portion 332 and the upper surface of the plate 34.

Two axially spaced-apart radial dynamic pressure generating grooves 3311 are formed in the inner circumferential surface 331 of the sleeve 33. Thrust dynamic pressure generating grooves 3321 are formed in the bottom surface of the first recessed portion 332 and the upper surface of the plate 34. Lubricating oil as a lubricant is filled between the sleeve 33 and the plate 34 and the shaft 21. During its rotation, the shaft 21 is rotatably supported in the axial direction and the radial direction by the dynamic pressures generated in the radial dynamic pressure generating grooves 3311 and the thrust dynamic pressure generating grooves 3321. The radial dynamic pressure generating grooves 3311, the thrust dynamic pressure generating grooves 3321 and the lubricating oil constitute the bearing mechanism BR.

Referring to FIG. 3, an inner circumferential wall portion 3331 protruding axially downwardly is formed on the outer peripheral side of the lower surface of the second recessed portion 333 of the sleeve 33. An outer circumferential wall portion 334 extending perpendicularly to the bottom surface of the second recessed portion 333, i.e., extending axially downwardly from the bottom surface of the second recessed portion 333, is formed radially outwardly of the second recessed portion 333.

The plate 34 makes contact with the lower surface of the inner circumferential wall portion 3331, whereby the axial height of the plate 34 relative to the sleeve 33 is determined. The plate 34 is inserted inside the outer circumferential wall portion 334. Therefore, the outer circumferential surface of the plate 34 comes into contact with a circumferential surface 3341 of the outer circumferential wall portion 334 or radially confronts the circumferential surface 3341 with a small gap left therebetween. The plate 34 and the sleeve 33 are bonded together by, e.g., laser welding. In the present embodiment, the plate 34 has a thickness of about 0.3 mm.

The inner circumferential wall portion 3331 has an inner slanting surface 3331a extending axially downwardly and radially outwardly on the inner circumference side thereof and an outer slanting surface 3331b extending axially downwardly and radially inwardly on the outer circumference side thereof. The outer slanting surface 3331b cooperates with the circumferential surface 3341 to form a recess portion 335 which is recessed upwardly to leave an axial gap between the upper surface of the plate 34 and the bottom surface of the second recessed portion 333 of the sleeve 33.

In this connection, it is possible to reduce the radial width of the lower surface of the inner circumferential wall portion 3331 by forming the inner slanting surface 3331a and the outer slanting surface 3331b. This reduces the contact area between the plate 34 and the inner circumferential wall portion 3331, thereby making it possible to reduce the tilt of the plate 34 which would be caused depending on the degree of planarity of the lower surface of the inner circumferential wall portion 3331. As a result, it becomes possible to mount the plate 34 to the sleeve 33 with increased accuracy. Particularly, it is possible in the present embodiment to easily perform the laser welding because the axial position of the plate 34 can be accurately determined by the lower surface of the inner circumferential wall portion 3331.

Referring to FIG. 4, the lower surface of the inner circumferential wall portion 3331 includes a first surface 3331c making contact with the upper surface of the plate 34 and a second surface 3331d axially spaced apart from the upper surface of the plate 34. The radial inner side of the inner circumferential wall portion 3331 communicates with the space enclosed by the recess portion 335 and the upper surface of the plate 34, through the gap existing between the upper surface of the plate 34 and the second surface 3331d. This allows the lubricating oil to be filled in the space enclosed by the recess portion 335 and the upper surface of the plate 34.

Therefore, the air present in the space is expelled to the outside of the bearing unit 11 so that the generation of air bubbles is reduced. As a consequence, it is possible to provide a highly reliable bearing unit by preventing the shaft 21 and the sleeve 33 from making direct contact with each other and eventually sticking together, which would otherwise be caused by the generation of air bubbles.

Formation of the second surface 3331d on the inner circumferential wall portion 3331 of the sleeve 33 eliminates the need for the plate 34 to have a portion for creating a gap between the plate 34 and the lower surface of the sleeve 33, e.g., a recessed portion, which makes it possible to simplify the shape of the plate 34, for example, to a flat plate shape. As a result, it is possible to reduce the thickness of the plate 34 and consequently to reduce the axial dimension of the bearing unit X1.

Referring again to FIG. 1, the outer circumferential wall portion 334 is located radially inwardly of the outer circumferential surface of the sleeve 33 fixed to the inner circumferential surface of the cylindrical holding portion 311 of the base 31. In other words, there is formed a radial gap between the outer circumferential surface of the outer circumferential wall portion 334 and the inner circumferential surface of the cylindrical holding portion 311.

Further, the sleeve 33 and the base 31 are bonded together by an adhesive agent. The adhesive agent can be collected in the radial gap formed between the outer circumferential surface of the outer circumferential wall portion 334 and the inner circumferential surface of the cylindrical holding portion 311. This makes it possible to attractively fix the sleeve 33 relative to the base 31. Consequently, it is possible to fix the sleeve 33 to the base 31 with increased accuracy.

The adhesive agent squeezed out between the inner circumferential surface of the cylindrical holding portion 311 of the base 31 and the outer circumferential surface of the sleeve 33 is gathered in the space between the outer circumferential surface of the outer circumferential wall portion 334 and the inner circumferential surface of the cylindrical holding portion 311.

### Motor Structure of Second Embodiment

Next, a motor in accordance with a second embodiment of the present invention will be described with reference to FIG. 5. FIG. 5 is an axially-cut schematic section view showing the motor in accordance with the second embodiment of the present invention. In FIG. 5, other components that remain unchanged in shape will be designated by the same reference numerals, and redundant descriptions thereof will be omitted. The components differing in shape will be designated by reference numerals having a suffix “a”.

Referring to FIG. 5, a motor 10a includes: a rotating part 20a having a rotor magnet 24a rotatable about a specified center axis J1; a fixed part 30a having a stator 32 arranged in a radially confronting relationship with the rotor magnet 24a for generating magnetic fields and a base 31a for holding the stator 32 in place; and a bearing mechanism BRa provided between the rotating part 20a and the fixed part 30a.

The rotating part 20a includes a shaft 21a coaxially arranged with the center axis J1 for rotating about the center axis J1, a rotor hub 22a fixed to an upper portion of the shaft 21a and provided with a disk support portion 224a for sustaining a rotated member (a disk in the present embodiment), and a rotor magnet 24a fixed to the rotor hub 22a.

The rotor hub 22a includes a shaft-fixed portion 221a fixed to the shaft 21a, a cover portion 222a formed axially below the shaft-fixed portion 221a to cover the upper side of the stator 32, an outer cylindrical portion 223a extending axially downwardly from the outer circumferential edge of the cover portion 222a, the disk support portion 224a formed in a radial center region of the cover portion 222a and provided with a supporting surface for sustaining the disk, and an inner cylindrical portion 225 formed radially inwardly of the outer cylindrical portion 223a but radially outwardly of the sleeve 33a. The rotor magnet 24a of a cylindrical shape is fixed to the inner circumferential surface of the outer cylindrical portion 223a of the rotor hub 22a. A removal-proof member 25 that makes contact with a part of the outer surface of the sleeve 33a to restrict axial upward movement of the rotating part 20a is fixed to the inner cylindrical portion 225.

The fixed part 30a includes a generally cylindrical sleeve 33a having an inner circumferential surface axially extending in a confronting relationship with the outer circumferential surface of the shaft 21a, a disk-like plate 34a for covering the lower side of the inner circumferential surface of the sleeve 33a, a base 31a having an axially bored cylindrical holding portion 311a with an inner circumferential surface to which the outer circumferential surface of the sleeve 33a is fixed, and a stator 32 having an inner circumferential surface fixed to the outer circumferential surface of the cylindrical holding portion 311a of the base 31a.

A yoke 35 formed of an annular magnetic body is fixed at a radial position on the base 31a axially opposite to the lower surface of the rotor magnet 24a.

The cylindrical holding portion 311a has at the outer circumferential portion thereof, a stator supporting surface 3111a for sustaining the stator 32 which is a radially annually extending flat surface, a first outer circumferential surface 3112a axially upwardly extending from the stator supporting surface 3111a and radially confronting the inner circumferential surface of the stator 32, and a second outer circumferential surface 3113a axially downwardly extending from the stator supporting surface 3111a. The inner cylindrical portion 225 of the rotor hub 22a is arranged inside the cylindrical holding portion 311a in a radially confronting relationship with the cylindrical holding portion 311a.

Magnetic fields are generated around the stator 32 by causing an electric current to flow through the coils 322 of the stator 32. Rotating magnetic fields are formed by the magnetic fields and the rotor magnet 24a, thereby producing a rotational driving force about the center axis J1 to rotate the rotating unit 20a.

<Structure of Bearing Unit>

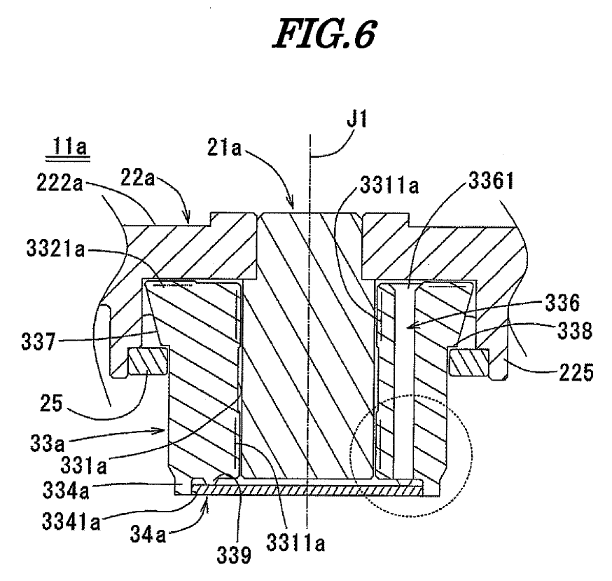

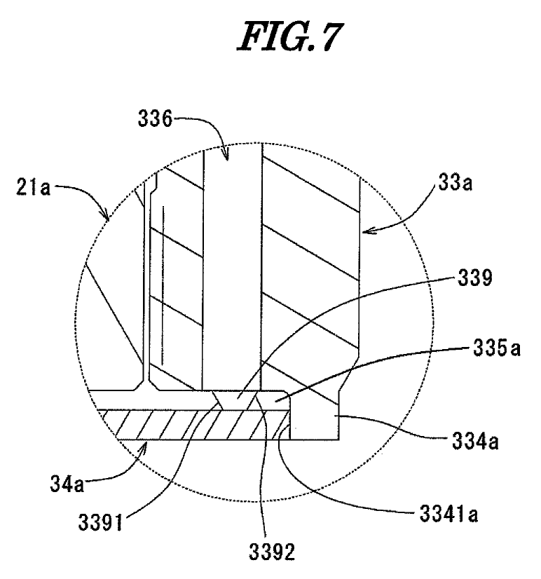

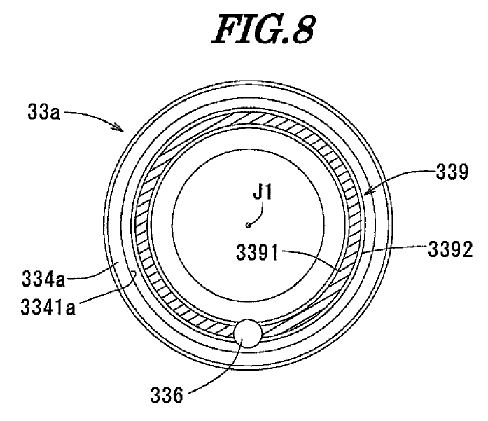

Next, a structure of a bearing unit 11a employed in the motor 10a in accordance with the second embodiment of the present invention will be described with reference to FIGS. 6 to 8. FIG. 6 is an axially-cut schematic section view showing the bearing unit 11a employed in the motor shown in FIG. 5. FIG. 7 is an enlarged view of the portion indicated by a dotted line circle in FIG. 6. FIG. 8 is a schematic bottom view of the sleeve 33a employed in the motor shown in FIG. 5.

Referring to FIG. 6, the bearing unit 11a of the motor 10a includes the shaft 21a, the rotor hub 22a, the sleeve 33a and the plate 34a.

The sleeve 33a includes an inner circumferential surface 331a confronting the outer circumferential surface of the shaft 21a, a lower surface, and an outer circumferential wall portion 334a extending axially downwardly from the lower surface of the sleeve 33a, the outer circumferential wall portion 334a having an inner circumferential surface 3341a.

Furthermore, the sleeve 33a is provided with a communication hole 336 through which the upper surface and the lower surface of the sleeve 33a communicate with each other. An increased diameter portion 3361 in which the diameter of the communication hole 336 is axially upwardly enlarged is formed between the communication hole 336 and the upper surface of the sleeve 33a. In particular, the communication hole 336 of the present embodiment is formed by cutting the sleeve 33a from the lower surface toward the upper surface thereof.

The increased diameter portion 3361 is also formed by a cutting work. The increased diameter portion 3361 is cut from the upper surface of the sleeve 33a after a through-hole as the communication hole 336 has been formed. In this connection, there is a possibility that burrs are generated on the upper surface side of the through-hole, because the through-hole as the communication hole 336 is formed through a cutting work. Even if burrs are generated on the upper surface side of the through-hole, however, it is possible to remove the burrs while forming the increased diameter portion 3361. This is because the increased diameter portion 3361 is formed by the cutting work. Therefore, it is possible to provide a highly reliable bearing unit.

The upper surface of the sleeve 33a and the lower surface of the cover portion 222a of the rotor hub 22a are arranged in a mutually confronting relationship, with a small axial gap left therebetween. On the outer circumference of the sleeve 33a continuously extending from the upper surface of the sleeve 33a, there is formed a slanting surface 337 that extends axially downwardly and radially inwardly. The inner cylindrical portion 225 of the rotor hub 22a is arranged in a radially confronting relationship with the slanting surface 337.

Below the slanting surface 337, there are formed a ring-shaped planar surface 338 joining to the slanting surface 337 and extending in the radial direction and an outer circumferential surface fixed to the base 31a. The planar surface 338 is arranged in an axially confronting relationship with the upper surface of the removal-proof member 25. The removal-proof member 25 makes contact with the planar surface 338 to restrict axial movement of the rotating part 20a.

Two axially spaced-apart radial dynamic pressure generating grooves 3311a are formed in the inner circumferential surface 331a of the sleeve 33a. Thrust dynamic pressure generating grooves 3321a are formed in the upper surface of the sleeve 33a radially outwardly of the communication hole 336. The plate 34a is fixed to the sleeve 33a such that it covers the lower side of the inner circumferential surface 331a. Lubricating oil as a lubricant is filled between the sleeve 33a and the plate 34a, between the sleeve 33a and the shaft 21a, and between the sleeve 33a and the rotor hub 22a. The lubricating oil is also filled the radial gap between the slanting surface 337 and the inner cylindrical portion 225.

Referring to FIG. 7; an inner circumferential wall portion 339 protruding axially downwardly is formed on the outer peripheral side of the lower surface of the sleeve 33a. The inner circumferential wall portion 339 has an inner slanting surface 3391 extending axially downwardly and radially outwardly on the inner circumference side thereof and an outer slanting surface 3392 extending axially downwardly and radially inwardly on the outer circumference side thereof. A recess portion 335a recessed axially upwardly is formed between the outer slanting surface 3392 and the circumferential surface 3341a.

The upper surface of the plate 34a makes contact with the lower surface of the inner circumferential wall portion 339, whereby the axial position of the plate 34a relative to the sleeve 33a is determined. The plate 34a is inserted inside the outer circumferential wall portion 334a. Therefore, the outer circumferential surface of the plate 34a comes into contact with the circumferential surface 3341a of the outer circumferential wall portion 334a or radially confronts the circumferential surface 3341a with a small gap left therebetween. The plate 34a and the sleeve 33a are bonded together by, e.g., laser welding. In the present embodiment, the plate 34a has a thickness of about 0.3 mm.

In this connection, it is possible to reduce the radial width of the lower surface of the inner circumferential wall portion 339 by forming the inner slanting surface 3391 and the outer slanting surface 3392. This reduces the contact area between the plate 34a and the lower surface of the inner circumferential wall portion 339, thereby making it possible to reduce the tilt of the plate 34a which would be caused depending on the degree of planarity of the lower surface of the inner circumferential wall portion 339. As a result, it becomes possible to mount the plate 34a to the sleeve 33a with increased accuracy. Particularly, it is possible in the present embodiment to easily perform the laser welding because the axial position of the plate 34a can be accurately determined by the lower surface of the inner circumferential wall portion 339.

Referring to FIGS. 7 and 8, the communication hole 336 is opened in the lower surface of the sleeve 33a substantially in the same radial position as the position of the inner circumferential wall portion 339. That it, the inner circumferential wall portion 339 is not formed in the circumferential position where the communication hole 336 exists.

In other words, the inner circumferential wall portion 339 is formed into a generally arc shape. In this regard, the communication hole 336 has a diameter greater than the radial width of the inner circumferential wall portion 339. The radial inner side of the inner circumferential wall portion 339 communicates with the radial outer side of the inner circumferential wall portion 339, i.e., the space enclosed by the recess portion 335a and the upper surface of the plate 34a, through the gap existing between the communication hole 336 and the upper surface of the plate 34a axially confronting the communication hole 336. This allows the lubricating oil to be filled in the space enclosed by the recess portion 335a and the upper surface of the plate 34a. Therefore, the air present in the space is expelled to the outside of the bearing unit 11a.

This makes it possible to restrain generation of air bubbles within the bearing unit 11a. As a consequence, it is possible to prevent the shaft 21a and the sleeve 33a from making direct contact with each other and eventually sticking together, which would otherwise be caused by the generation of air bubbles. Accordingly, it becomes possible to provide a highly reliable bearing unit.

Furthermore, there is no need for the plate 34a to have a portion for creating a gap between the plate 34a and the lower surface of the sleeve 33a, e.g., a recessed portion, because the communication hole 336 is opened substantially in the same radial position as the position of the inner circumferential wall portion 339 and because the inner circumferential wall portion 339 is not formed in the opened position. Therefore, it is possible to form the plate 34a into a simple shape such as a flat plate shape or the like. As a result, it is possible to reduce the thickness of the plate 34a and consequently to reduce the axial dimension of the bearing unit 11a.

Referring again to FIG. 5, the outer circumferential wall portion 334a is located radially inwardly of the outer circumferential surface of the sleeve 33a fixed to the inner circumferential surface of the cylindrical holding portion 311a of the base 31a. In other words, there is formed a radial gap between the outer circumferential surface of the outer circumferential wall portion 334a and the inner circumferential surface of the cylindrical holding portion 311a.

The sleeve 33a and the base 31a are bonded together by an adhesive agent. In this regards the adhesive agent can be collected in the radial gap formed between the outer circumferential surface of the outer circumferential wall portion 334a and the inner circumferential surface of the cylindrical holding portion 311a. This makes it possible to attractively fix the sleeve 33a relative to the base 31a. Consequently, it is possible to fix the sleeve 33a to the base 31a with increased accuracy.

The adhesive agent squeezed out between the inner circumferential surface of the cylindrical holding portion 311a of the base 31a and the outer circumferential surface of the sleeve 33a is gathered in the space between the outer circumferential surface of the outer circumferential wall portion 334a and the inner circumferential surface of the cylindrical holding portion 311a. Particularly, it is possible to locate the outer circumferential wall portion 334a on the radial inner side of the outer circumferential surface of the sleeve 33a, because the communication hole 336 is formed substantially in the same position as the position of the inner circumferential wall portion 339.

In a hypothetical case that the communication hole 336 and the inner circumferential wall portion 339 are located in different radial positions, it becomes necessary to provide independent spaces for forming the communication hole 336 and the inner circumferential wall portion 339. This increases the radial dimension of the bearing unit 11a. Moreover, in order to expel the air present in the space between the recess portion 335a and the upper surface of the plate 34a to the outside of the bearing unit 11a, a gap needs to be formed in a part of the inner circumferential wall portion 339 that communicates the space existing radially inwardly of the inner circumferential wall portion 339 to the space between the recess portion 335a and the upper surface of the plate 34a.

In the present embodiment, however, it is possible to reduce the radial dimension of the bearing unit 11a by forming the communication hole 336 and the inner circumferential wall portion 339 substantially in the same radial position. It is also possible to simplify the shape of the bearing unit 11a because the communication hole 336 can provide a gap through, which the space existing radially inwardly of the inner circumferential wall portion 339 communicates with the space between the recess portion 335a and the upper surface of the plate 34a.

<Structure of modified Bearing Unit>

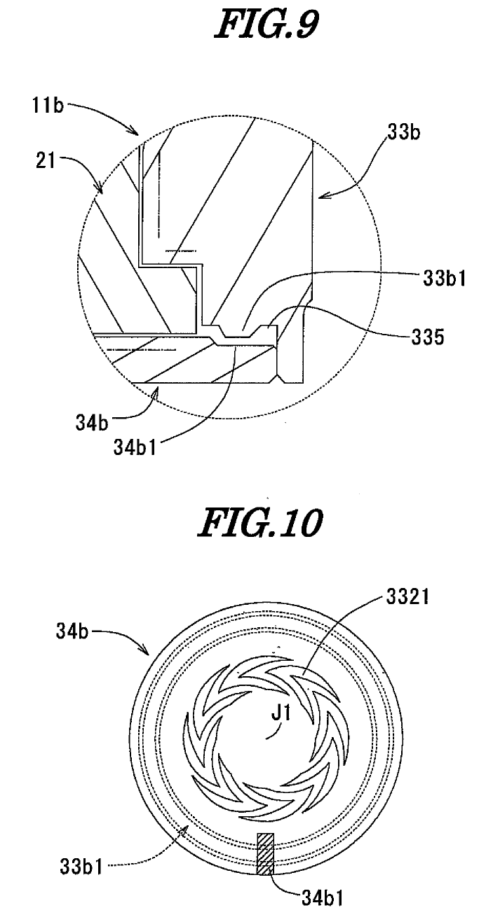

Next, modification of the bearing unit in accordance with the first embodiment of the present invention will be described with reference to FIGS. 9 and 10. FIG. 9 is an axially-cut schematic section view of the modified bearing unit. FIG. 10 is a bottom view of a plate 34b employed in the bearing unit shown in FIG. 9. The bearing unit and the plate shown in FIGS. 9 and 10 are embodied by partially modifying the structures of the plate 34 and the sleeve 33 shown in FIG. 2. Differing points that distinguish over the configuration shown in FIG. 2 will be described below but description of the others will be omitted.

Referring to FIG. 9, the inner circumferential wall portion 33b1 of the sleeve 33b is formed into an annular shape. The lower surface of the inner circumferential wall portion 33b1 makes contact with the upper surface of the plate 34b. Referring to FIG. 10, a recess portion 34b1 recessed axially downwardly is formed in the plate 34b. The recess portion 34b1 radially extends from the radial inner side of the inner circumferential wall portion 33b1 to the radial outer side thereof. Thus, the space existing radially inwardly of the inner circumferential wall portion 33b1 is allowed to communicate with the space enclosed by the recess portion 335 and the upper surface of the plate 34b, through an axial gap between the upper surface of the recess portion 34b1 and the inner circumferential wall portion 33b1.

This allows the lubricating oil to be filled in the space enclosed by the recess portion 335 and the upper surface of the plate 34b. Therefore, the air present in the space is expelled to the outside of the bearing unit 11b. This makes it possible to restrain generation of air bubbles within the bearing unit 11b. As a consequence, it is possible to prevent the shaft 21 and the sleeve 33b from making direct contact with each other and eventually sticking together, which would otherwise be caused by the generation of air bubbles. Accordingly, it becomes possible to provide a highly reliable bearing unit.

<Disk Drive Apparatus>

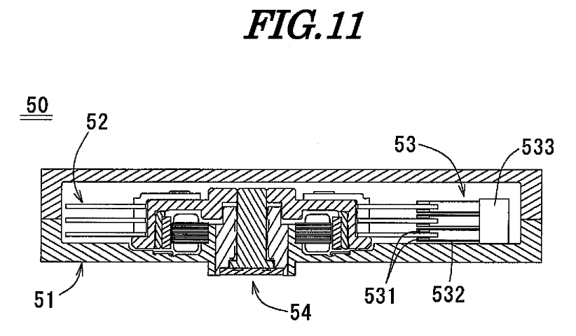

Next, a structure of a disk drive apparatus in accordance with the present invention will be described with reference to FIG. 11. FIG. 11 is an axially-cut schematic section view showing a disk drive apparatus in accordance with the present invention.

Referring to FIG. 11, a disk drive apparatus 50 includes a rectangular housing 51. The interior of the housing 51 is formed of a clean space where debris, dust or the like is kept in an extremely small amount. Arranged within the housing 51 is a motor 54, which mounts a hard disk 52 as a disk for storing information therein is mounted.

An access mechanism 53 for reading and writing information from and on the hard disk 52 is arranged within the housing 51. The access mechanism 53 includes a magnetic head 531 for reading and writing information from and on the hard disk 52, an arm 532 for supporting the magnetic head 531 and an actuator part 533 for moving the magnetic head 531 and the arm 532 to a desired position on the hard disk 52.

The motor 10 or 10a of the present invention, that hardly generates air bubbles within the bearing unit 11 or 11a, is employed as the motor 54 of the disk drive apparatus 50. This makes it possible to provide a highly reliable disk drive apparatus.

While the invention has been shown and described with respect to the embodiment, it will be understood by those skilled in the art that various changes and modifications may be made without departing from the scope of the invention as defined in the following claims.

Specifically, although the sleeve 33, 33a or 33b is formed of a single member in the embodiments of the present invention, the present invention is not limited thereto. As an alternative example, the portion of the sleeve in which the dynamic pressure generating grooves are formed may be a separate member. Particularly, it is preferred that the separate member be made of a sintered material.

Although the communication hole 336 is formed along the axial direction in one embodiment of the present invention, the present invention is not limited thereto. As an alternative example, the communication hole 336 may be inclined to extend axially upwardly and radially outwardly. In this case, the thrust dynamic pressure generating groves 3321a is formed radially inwardly of the communication hole 336.

Although the first surface 3331c and the second surface 3331d are formed in the inner circumferential wall portion 3331 as shown in FIG. 3 or the recess portion 34b1 is formed on the upper surface of the plate 34 34b as shown in FIG. 9 in the embodiments of the present invention, the present invention is not limited thereto. As an alternative example, these two configurations may be used in combination.

Although the sleeve 33 or 33a and the plate 34 or 34a are bonded together by laser welding in the embodiments of the present invention, the present invention is not limited thereto. As an alternative example, the sleeve 33 or 33a and the plate 34 or 34a may be fixed to each other by caulking or with an adhesive agent.

What is claimed is:

1. A bearing unit comprising:
a shaft coaxially arranged with a specified center axis;
a generally tubular bearing member having an axially extending through-hole into which the shaft is inserted;
a generally planar plate fixed to an axial lower side of the bearing member for covering an axial lower side of the through-hole; and
a lubricant filled between the shaft and an inner circumferential surface of the bearing member,
wherein the bearing member includes: a generally annular or generally arc-shaped inner circumferential wall portion axially downwardly protruding from a lower surface of the bearing member, the inner circumferential wall portion having a first surface contacting with an upper surface of the plate and extending in a parallel relationship with the upper surface of the plate and a second surface axially spaced apart from the upper surface of the plate so that an axial gap is left between the second surface and the upper surface of the plate, the second surface being located generally radially identical with the first surface; and an outer circumferential wall portion positioned radially outwardly of the second surface, the outer circumferential wall portion having a circumferential surface downwardly extending relative to the second surface along a generally axial direction,
wherein the plate is fixed to the outer circumferential wall portion of the bearing member,
wherein a radial inner side of the inner circumferential wall portion communicates with the outer circumferential wall portion through the axial gap formed between the second surface and the plate.

2. A bearing unit comprising:
a shaft coaxially arranged with a specified center axis;
a generally cylindrical bearing member having an axially extending through-hole into which the shaft is inserted and a communication hole arranged radially outwardly of the through-hole, the communication hole extending from an upper surface to a lower surface of the bearing member;
a generally planar plate fixed to an axial lower side of the bearing member for covering an axial lower side of the through-hole; and
a lubricant filled between the shaft and an inner circumferential surface of the bearing member,
wherein the bearing member includes: a generally arc-shaped inner circumferential wall portion formed in a radially identical position with the communication hole, the inner circumferential wall portion protruding axially downwardly from the lower surface of the bearing member over a circumferentially different position than the communication hole to make contact with an upper surface of the plate; and a generally annular outer circumferential wall portion positioned radially outwardly of the inner circumferential wall portion, the outer circumferential wall portion having a circumferential surface extending in a generally axial direction.

3. A bearing unit comprising:
a shaft coaxially arranged with a specified center axis;
a generally tubular bearing member having an axially extending through-hole into which the shaft is inserted;
a generally planar plate fixed to an axial lower side of the bearing member for covering an axial lower side of the through-hole; and
a lubricant filled between the shaft and an inner circumferential surface of the bearing member,
wherein the bearing member includes: an inner circumferential wall portion axially downwardly protruding from a lower surface of the bearing member to make contact with an upper surface of the plate; an outer circumferential wall portion having a circumferential surface extending in a generally axial direction; and an annular upper recess portion radially formed between the inner circumferential wall portion and the outer circumferential wall portion and axially upwardly recessed from a lower end of the inner circumferential wall portion,
wherein the plate is fixed to the outer circumferential wall portion of the bearing member,
wherein a recess portion which is extending radially and recessed downwardly is formed in a circumferentially partial region of the upper surface of the plate,
wherein a radial inner side of the inner circumferential wall portion communicates with the outer circumferential wall portion through the recess portion of the plate.

4. The bearing unit of claim 2, wherein the communication hole is joined to the upper surface of the bearing member by means of a slanting surface whose diameter is increased upwardly.

5. The bearing unit of claim 1, wherein the inner circumferential wall portion has an outer slanting surface extending downwardly and radially inwardly.

6. The bearing unit of claim 2, wherein the inner circumferential wall portion has an outer slanting surface extending downwardly and radially inwardly.

7. The bearing unit of claim 3, wherein the inner circumferential wall portion has an outer slanting surface extending downwardly and radially inwardly.

8. The bearing unit of claim 1, wherein the shaft includes an increased diameter portion having an upper surface axially confronting the lower surface of the bearing member, the increased diameter portion having an outer edge located radially inwardly of the inner circumferential wall portion.

9. The bearing unit of claim 2, wherein the shaft includes an increased diameter portion having an upper surface axially confronting the lower surface of the bearing member, the increased diameter portion having an outer edge located radially inwardly of the inner circumferential wall portion.

10. The bearing unit of claim 3, wherein the shaft includes an increased diameter portion having an upper surface axially confronting the lower surface of the bearing member, the increased diameter portion having an outer edge located radially inwardly of the inner circumferential wall portion.

11. A bearing unit comprising:
a shaft coaxially arranged with a specified center axis;
a generally tubular bearing member having an axially extending through-hole into which the shaft is inserted;
a generally planar plate fixed to an axial lower side of the bearing member for covering an axial lower side of the through-hole; and
a lubricant filled between the shaft and an inner circumferential surface of the bearing member,
wherein the bearing member includes: an inner circumferential wall portion axially downwardly protruding from a lower surface of the bearing member to make contact with an upper surface of the plate; and an outer circumferential wall portion having a generally axially extending circumferential surface formed radially outwardly of the inner circumferential wall portion,
wherein the plate is fixed to the outer circumferential wall portion of the bearing member,
wherein a gap is formed between the inner circumferential wall portion and the plate so that a space formed radially inwardly of the inner circumferential wall portion communicates in a radial direction with a space formed radially outwardly of the inner circumferential wall portion through the gap.

12. A motor provided with the bearing unit of claim 1, comprising:
a rotating part, rotatable together with the shaft, having a rotor magnet; and
a fixed part including a housing having an inner circumferential surface for holding an outer circumferential surface of the bearing member and a stator fixed to the housing in a confronting relationship with the rotor magnet for generating magnetic fields.

13. A motor provided with the bearing unit of claim 2, comprising:
a rotating part, rotatable together with the shaft, having a rotor magnet; and
a fixed part including a housing having an inner circumferential surface for holding an outer circumferential surface of the bearing member and a stator fixed to the housing in a confronting relationship with the rotor magnet for generating magnetic fields.

14. A motor provided with the bearing unit of claim 3, comprising:
a rotating part, rotatable together with the shaft, having a rotor magnet; and
a fixed part including a housing having an inner circumferential surface for holding an outer circumferential surface of the bearing member and a stator fixed to the housing in a confronting relationship with the rotor magnet for generating magnetic fields.

15. A motor provided with the bearing unit of claim 11, comprising:
a rotating part, rotatable together with the shaft, having a rotor magnet; and
a fixed part including a housing having an inner circumferential surface for holding an outer circumferential surface of the bearing member and a stator fixed to the housing in a confronting relationship with the rotor magnet for generating magnetic fields.

16. The motor of claim 12, wherein the bearing member and the housing are fixed to each other by an adhesive agent, wherein the outer circumferential wall portion has an outer circumferential surface formed radially inwardly of the outer circumferential surface of the bearing member in such a manner as to confront the inner circumferential surface of the housing with a radial gap left between the outer circumferential surface of the outer circumferential wall portion and the inner circumferential surface of the housing, and wherein the adhesive agent is collected between the outer circumferential surface of the outer circumferential wall portion and the inner circumferential surface of the housing.

17. A disk drive apparatus equipped with the motor of claim 1, comprising:
a disk mounted to the rotating part;
an access mechanism performing at least one of recording information on and reproducing information from the disk; and
an actuator for moving the access mechanism.

18. A disk drive apparatus equipped with the motor of claim 2, comprising:
a disk mounted to the rotating part;
an access mechanism performing at least one of recording information on and reproducing information from the disk; and
an actuator for moving the access mechanism.

19. A disk drive apparatus equipped with the motor of claim 3, comprising:
a disk mounted to the rotating part;
an access mechanism performing at least one of recording information on and reproducing information from the disk; and
an actuator for moving the access mechanism.

20. A disk drive apparatus equipped with the motor of claim 11, comprising:
a disk mounted to the rotating part;
an access mechanism performing at least one of recording information on and reproducing information from the disk; and
an actuator for moving the access mechanism.
